(19) United States
(12) Patent Application Publication
(10) Pub. No.: US 2006/0161776 A1
(43) Pub. Date: Jul. 20, 2006

(54) Embedding watermarks for protecting multiple copies of a signal

(76) Inventors: Minne Van Der Veen, Eindhoven (NL); Antonius Adrianus Cornelis Maria Kalker, Mountain View, CA (US)

Correspondence Address: PHILIPS INTELLECTUAL PROPERTY & STANDARDS, P.O. BOX 3001, BRIARCLIFF MANOR, NY, 10510, US

(21) Appl. No.: 10/564,295

(22) PCT Filed: Jul. 2, 2004
(86) PCT No.: PCT/IB04/51103

§ 371 Date: Jan. 10, 2006

(30) Foreign Application Priority Data
Jul. 10, 2003 (EP) 03102097.7

(51) Int. Cl. H04L 9/00

(52) U.S. Cl. 713/176

(57) ABSTRACT

The present invention relates to methods, devices and a signal related to simplifying the embedding of watermarks in different copies of a media signal (x). The watermarking process is split into two parts, one that is based on signal dependent properties and one that is based on watermark specific properties. The signal dependent properties are determined in advance, while the watermark specific properties are determined at the time of delivery of the media signal. The signal dependent watermarking properties (p) of a media signal (x) are determined in a properties determining unit (14) and stored in a signal properties store (16), such that the signal dependent properties can be used for embedding more than one watermark (W_{A}, W_{B}, W_{C}) in different copies of the media signal. In this way it is possible to embed watermarks in multiple copies of the same media signal with small time delays.

The present invention generally relates to the field of watermarking of media signals and more particularly to methods, devices and a media signal for simplifying embedding of watermarks in different copies of a media signal.

It is widely known to watermark media signals in order to prevent illegal copying and distribution of the media signals. In this way a rightful owner of a media signal can detect if for instance copies of a media signal have been illegally made.

With the introduction of Internet, there has been revolution within the filed of distribution of media content, through allowing downloading of media signals from Electronic Content Delivery Systems. A content provider can then have a database of different media signals and deliver copies of these to different users via the Internet. A purchaser of this content then often expects an instantaneous or direct delivery of access to the content. In order to safeguard illegal copying of these media signals it is then necessary to watermark each copy distributed with a unique watermark.

Watermarking is however in many cases relatively time consuming and involving complex computing operations. This means that if a content provider is to deliver many copies of a media signal at the same time to different clients, the watermarking process for each copy of the media signal will take a long time, which can lead to many clients receiving their ordered media signal after a considerable delay, which is in many cases not acceptable.

There is therefore a need for providing watermarking of different copies of a media signal that is faster, while still guaranteeing unique watermarks for each watermarked copy.

The document “Real-time Concepts for Block-based Watermarking Schemes” by Michael Arnold and Oliver Lobisch, WEDELMUSIC Conference, 2002, Darmstadt, Germany, pp. 156-160, describes one system for reducing the computational time used. Here a media signal is watermarked with two different watermarks. The two watermarked copies of the media signal are then stored. Just prior to distributing the signal to different clients, the watermarked signals are then mixed in a client dependent way in order to provide unique watermarks for different clients. This technique works best when the media signal is provided in frames. Then at every frame boundary one out of the two watermarked signals are mixed into the output signal. In this way an output media signal can be provided such that a sequence of the two watermarks are provided on a frame-per-frame basis. The specific sequence then represents the watermark of a certain client. The document furthermore describes the use of a secret key that determines the order in which the two watermarks are provided. A similar system is also described in the document WO00/56059.

Many types of watermarking do not use frames. In for instance mask coding there is a continuous sequence of symbols. Mixing of watermarks is possible in this environment. The mixing is however difficult to perform and such mixed watermarks would furthermore be difficult to detect. The payload capacity is furthermore limited by the maximum number of possible changes in the watermarking sequence. If the watermarking algorithm properties do not allow a relatively fast change in watermark and/or content size is relatively small, the total payload may be limited. The storage capacity for storing the watermarks furthermore needs to be increased significantly because of the storing space requirements for the two watermarks.

There is thus a need for an alternative way of providing watermarking of different copies of a media signal that is faster, while still guaranteeing unique watermarks for each watermarked copy and that furthermore limits the storage capacity needed, allows a bigger variation of unique watermarks, especially for small sized media content, and that can be used for also other watermarking techniques that do not use frames.

It is thus an object of the present invention to provide watermarking of different copies of a media signal that is fast, while still guaranteeing unique watermarks for each watermarked copy, limits the storage capacity needed, allows a bigger variation of unique watermarks and that can be used for watermarking techniques that do not use frames.

According to a first aspect of the present invention, this object is achieved by a method of simplifying embedding of watermarks in different copies of a media signal comprising the steps of:

determining watermarking properties dependent on a media signal, and

storing the signal dependent properties, such that the signal dependent properties can be used when embedding unique watermarks in different copies of the media signal.

According to a second aspect of the present invention, this object is also achieved by a method of embedding a watermark in a media signal comprising the steps of:

receiving a media signal together with certain watermarking properties dependent on the media signal, and

embedding a watermark based on the signal dependent properties in a copy of the media signal.

According to a third aspect of the present invention, this object is furthermore achieved by a device for simplifying the embedding of watermarks in different copies of a media signal comprising a server unit including:

a properties determining unit for determining signal dependent watermarking properties of a media signal, and

a signal properties store for storing the signal dependent properties, such that the signal dependent properties can be used for embedding unique watermarks in different copies of the media signal.

According to a fourth aspect of the present invention, this object is furthermore achieved by a device for embedding a watermark in a media signal comprising:

a receiving unit for receiving a media signal together with certain watermarking properties dependent on the media signal, and

a watermarking unit arranged to embed a watermark based on the signal properties in a copy of the media signal.

According to a fifth aspect of the present invention, this object is also achieved by a signal for providing media content to a recipient comprising a media signal together with certain watermarking properties, which are dependent on the media signal.

Claims 2 and 12 are directed towards sending the media signal together with information that is at least based on the signal dependent properties to a recipient.

Claims 3 and 13 are directed towards embedding watermarks in copies of the media signal using the signal dependent properties and then sending the media signal including a unique watermark to recipients. In this way watermarks are embedded before delivery to recipients.

Claims 4 and 14 are directed towards mixing watermarks in copies of the media signal. This enables the provision of unique watermarks in several copies of a media signal based on a limited number of original watermarks with only limited additional processing.

Claims 5 and 15 are directed towards sending the media signal and the signal dependent properties to a recipient. In this way a trusted client can himself embed a unique watermark in the media signal. This also allows inspection of effects on the watermarking on the media signal beforehand, which allows modification of the signal dependent properties of a watermark before embedding.

Claims 6, 10, 16 and 19 are directed towards lossless encoding and decoding of the signal dependent properties in the media signal. This has the advantage of not requiring any extra bandwidth for the transmission of the signal dependent properties.

Claims 7 and 17 are directed towards using a perceptual model of a human sensing system for determining the signal dependent properties.

The present invention has the advantage of allowing embedding of watermarks in multiple copies of the same media signal with small time delays. The storage requirements are furthermore smaller than if several parallel watermarks are stored.

The general idea behind the invention is thus to split the watermarking process into two parts, one which is based on signal dependent properties and one which is based on watermark specific properties. The signal dependent properties are determined in advance, while the watermark specific properties are determined at the time of delivery of the media signal.

These and other aspects of the invention will be apparent from, and elucidated with reference to, the embodiments described hereinafter.

The present invention will now be explained in more detail in relation to the enclosed drawings, by way of example, where

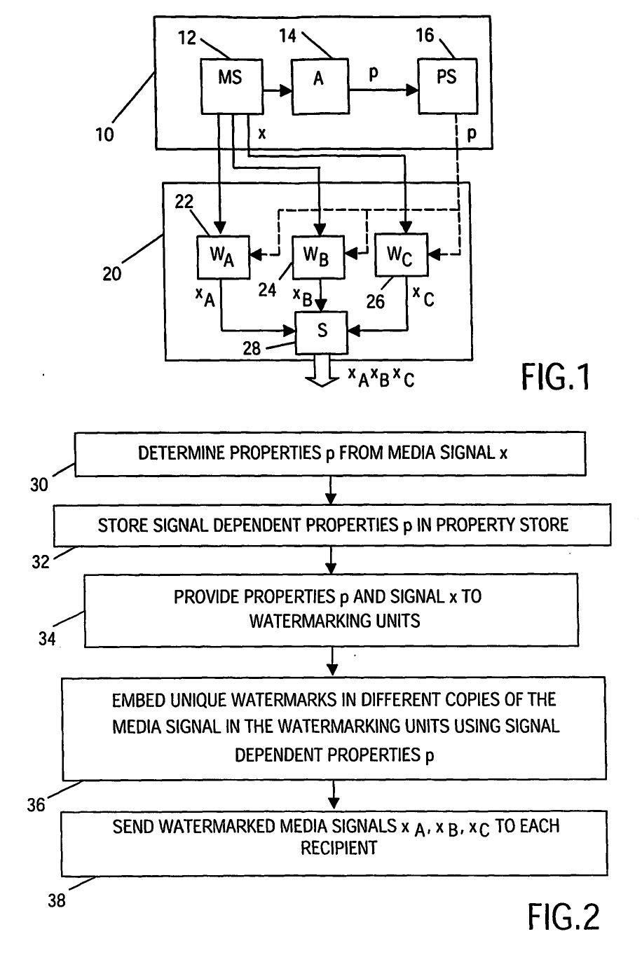

FIG. 1 shows a block schematic of a device for simplifying embedding of watermarks in copies of a media signal according to a first embodiment of the invention,

FIG. 2 shows a flow chart of the method of simplifying embedding of watermarks in a media signal the device in FIG. 1 is working according to,

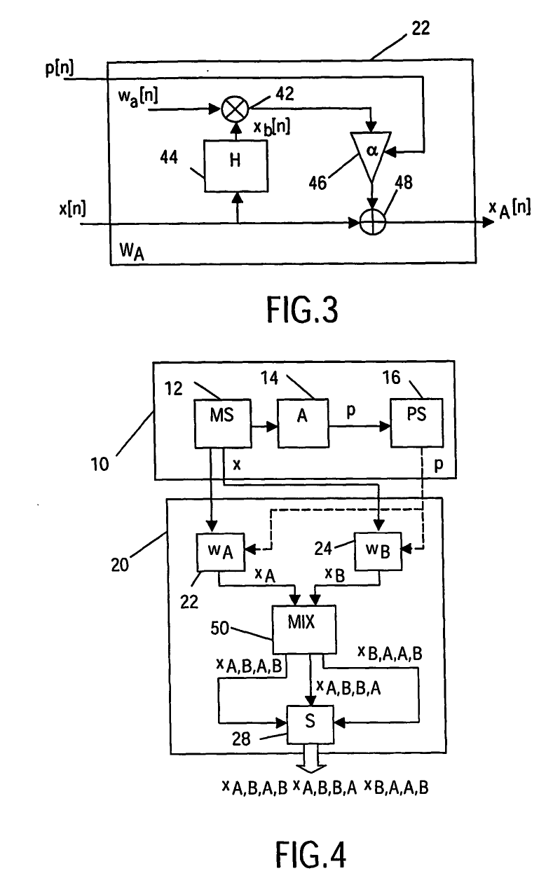

FIG. 3 shows a block schematic of a watermarking unit that can be used in the device in FIG. 1,

FIG. 4 shows a block schematic of a device for simplifying embedding of watermarks in copies of a media signal according to a second embodiment of the invention,

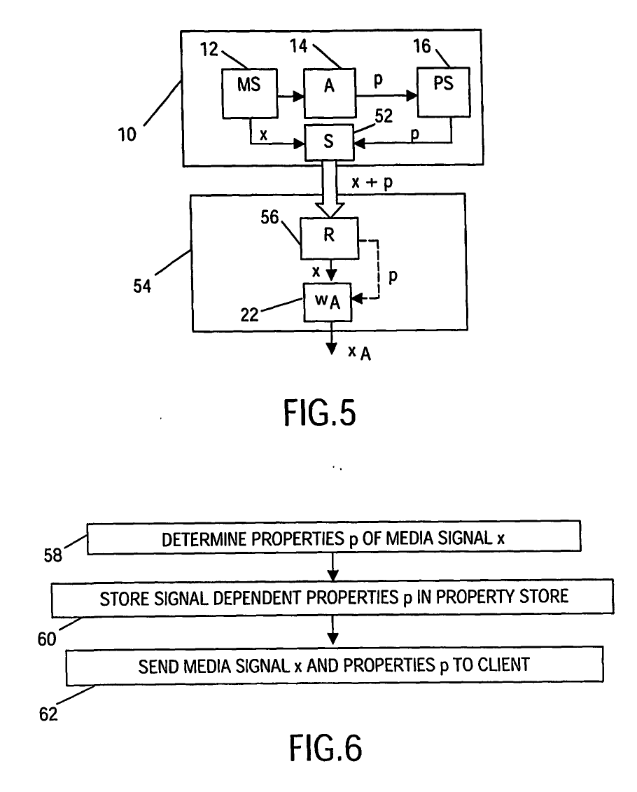

FIG. 5 shows a block schematic of a server device for simplifying embedding of watermarks in copies of a media signal together with a corresponding client device according to a third embodiment of the invention,

FIG. 6 shows a flow chart of a method of simplifying embedding of watermarks in a media signal, that the server device in FIG. 5 is working according to,

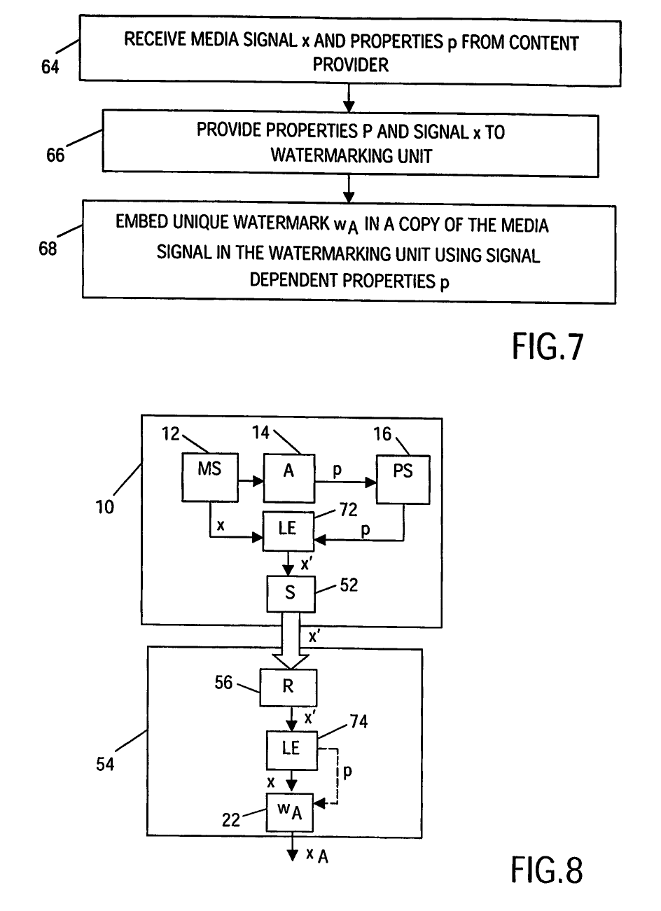

FIG. 7 shows a flow chart of a method of simplifying embedding of watermarks in a media signal, that the client device in FIG. 5 is working according to, and

FIG. 8 shows a block schematic of a server device for simplifying embedding of watermarks in copies of a media signal together with a corresponding client device according to a fourth embodiment of the invention.

The present invention relates to the field of providing watermarks in media signals and is especially arranged for provision of watermarks in electronic media signal delivery systems.

FIG. 1 shows a block schematic of a device for simplifying embedding of watermarks in copies of a media signal according to a first embodiment of the invention. The device includes a server unit 10 and a media signal delivery unit 20, which are connected to each other. The functioning of the device will now also be described in relation to FIG. 2, which shows a flow chart of the method the device is working according to. The server unit includes a media store MS 12 including a number of media signals, such as for instance a number of audio signals, like a number of songs. The media store 12 is connected to an analyzing unit 14, which determines watermarking properties p that are based on the media signal x to be watermarked, step 30. After having determined these properties the analyzing unit 14 stores these properties p in a property store PS 16, step 32. This determination is performed for all signals in the store 12 and is furthermore performed off-line, i.e. in advance of any delivery or request for delivery of a media signal to a client or recipient.

When the device receives requests for certain media content, the server unit forwards the media signal x from the signal store and the properties p corresponding to the signal to a number of watermarking units 22, 24, 26 in the signal delivery unit 20, step 34. In FIG. 1, there are three such units shown, each embedding a unique watermark wₐ, w_{b, w}_{c} in the media signal x, step 36. The watermarks wₐ, w_{b}, w_{c} can here be seen as watermark dependent properties. When performing this embedding the watermarking units use the signal dependent properties p. How this can be done will shortly be described in more detail. Thereafter the watermarked signals xₐ, x_{b}, x_{c} are provided to a sending unit 28, which sends the thus watermarked media signals xₐ, x_{b}, x_{c} to the recipients, step 38. This sending is in FIG. 1 indicated with a thick arrow. The actual watermarking is here provided on-line, i.e. when the signal is to be delivered, so that watermarking is taking place just before a signal is to be delivered, which enables delivery on demand even if many clients wish to receive a media signal. The sending is of course also provided on-line. The sending unit is a normal interface adapted to be used for the transmission medium in question, which in the present example is the Internet.

With this device a number of advantages are obtained. It is possible to embed watermarks in multiple copies of the same media signal with small time delays, because the signal dependent properties have been determined beforehand. The storage requirements are furthermore smaller than if several parallel watermarks are stored, since only one copy of these signal properties are stored, which are then used for all watermarks embedded in a copy of the media signal.

There are some variations of this first embodiment that are obvious. First of all it is possible to have only one watermarking unit instead of three, which could provide all the watermarking. Then it would be having different watermarks as input information. It should therefore also be realized that more or fewer watermarking units can be used in parallel. Another obvious modification is that the units 10 and 20 can be combined into one single unit. They can also be provided in a network, which would then preferably be a separate network from the network on which the signal is sent to the client, although this is no requirement. It is also possible to provide several units 20, each communicating with the server 10.

How an actual watermarking unit can be made to work will now be described with reference being made to FIG. 3, which shows a block schematic of an envelope modulation watermarking unit 22. The device is a device for watermarking of signal samples, like for instance of audio signal samples like PCM samples. This is however just one example of the type of signals in which watermarking according to the invention can be performed. It should be realized that the watermarking principles of the present invention can just as well be applied on compressed audio signals as well as on image or video signals, either compressed or decompressed. The watermarking unit 22 includes a bandpass filter 44, which filters the media signal x[n] and provides the filtered signal x_{b}[n] to a multiplying unit 42, which also receives a watermark wₐ[n] and multiplies the watermark wₐ[n] with the filtered media signal x_{b}[n]. The output of the multiplying unit 42 is connected to a scaling unit 46, which scales the output signal from the multiplying unit 42 with a scaling parameter α and provides it to an adding unit 48, which also receives the media signal x[n]. The output of the adding unit 48 is then the watermarked media signal x_{A}[n]. The scaling factor α is controlled by a signal p[n], which signal is made up of the watermarking properties depending on the media signal. These properties are in this example decided based on a psycho-acoustic model of the human hearing system in order to ensure that the watermark is not perceptible to a user or client or provided beneath a masking threshold of the signal x[n]. These properties, which are highly dependent on the media signal x, are therefore calculated beforehand and stored in the properties store in FIG. 1. The calculation of these properties is quite complex and time demanding, but is however only needed to be made once for each signal. Also the bandpass filtered signal x_{b}[n] is fixed in the sense that it is not influenced by the watermark and can just as well be calculated beforehand and stored in the properties store. This will make the watermarking unit simpler in structure but also require additional storage space in the server. It should be realized that the watermarking properties dependent on the media signal are not limited to being based on a psycho-acoustic model of the human hearing system. In case the media signal is a still image or a video signal an appropriate psycho-visual model of the human visual system is used. The model is therefore a model of a human sensing system. More detail about the specific watermarking technique shown in FIG. 3 can be found in the document, “A temporal domain audio watermarking technique”, by Aweke Negash Lemma, Javier Aprea, Werner Oomen and Leon van de Kerkhof, IEEE Transactions on Signal Processing, April 2003, Vol. 51, page 1088-1097, which is herein incorporated by reference.

According to a second embodiment of the invention, it is possible to also mix together two watermarks in order to increase the payload capacity of the watermark. A device for simplifying embedding of watermarks in copies of a media signal according to this second embodiment of the invention is shown in a block schematic in FIG. 4. Here the server unit 10 is identical with the server unit in FIG. 1. The notable difference here is that the signal delivery unit 20 includes two watermarking units 22 and 24 instead of three as well as a mixing unit 50 provided between the sending unit 28 and the watermarking units 22, 24. The server unit 10 here works in the same way as the server unit in FIG. 1 and will therefore not be described in more detail. Also the watermarking units 22 and 24 work in the same way as has been described in relation to FIG. 1, and will therefore not be described in more detail. The mixer 50 receives the two watermarked copies xₐ and x_{b} of the signal x and mixes them so that different sections of the signal x is watermarked with one of the watermarks in a sequence determined by the mixer. In FIG. 4 only four sections are indicated in the output signals from the mixer. It should however be understood that more or fewer sections could be provided. The mixer thus outputs different combinations of the watermarks wₐ and w_{b}, embedded in copies of the media signal, where the number of combinations in the given example can be sixteen. In the figure only three are however shown x_{A,B,A,B}, x_{A,B,B,A}, x_{B,A,A,B}. It should also be understood that if more sections are used the number of possible combinations are increased. Another possible variation is to mix more than two watermarked signals. The thus mixed signals are then provided to the sending unit 28 for sending to different clients. How this mixing can be performed in more detail is described in the document “Real-time Concepts for Block-based Watermarking Schemes” by Michael Arnold and Oliver Lobisch, WEDELMUSIC Conference, 2002, Darmstadt, Germany, pp. 156-160, which is herein incorporated by reference.

With the device in FIG. 4, the payload capacity is increased. The device furthermore allows the provision of unique watermarks in several copies of a media signal based on a limited number of original watermarks with only limited additional processing and thus a slightly slower watermarking speed.

The first and second embodiment were described in relation to a system of delivering media signals to clients, where the system embeds watermarks before supply to a client. This system is a consumer system, where the client is not a trusted party. The present invention is however also applicable in systems where the client is a trusted type of client, which can for instance be a company. This system can for example be used for delivering video signals carrying movie information to a cinema.

A third embodiment of the present invention is directed towards this type of environment. A server for simplifying embedding of watermarks in copies of a media signal together with a client device performing the watermark embedding according to this third embodiment of the invention is shown in a block schematic in FIG. 5. The functioning of this system will now also be described in relation also to FIGS. 6 and 7, which show flow charts of the method the server and the client devices are working according to.

As mentioned above the server unit includes a media store MS 12 including a number of media signals. The media store 12 is connected to the analyzing unit 14, which determines watermarking properties p that are based on the media signal x to be watermarked, step 58. After having determined these properties the analyzing unit 14 stores these properties p in the property store PS 16, step 60. This determination is performed for all signals in the store 12 and is furthermore performed off-line, i.e. in advance of any delivery of the media signal to the client. The server unit 10 also includes a sending unit 52 which sends the media signal x as well as the watermark properties p that depend on the media signal, step 62. This sending is in FIG. 5 indicated with a thick arrow. The information is furthermore preferably sent using encryption.

The client device 54 includes a receiving unit 56, where the properties and the media signal are received, step 64. The client device also includes a watermarking unit 22. The receiving unit 56 therefore provides the media signal x and the properties p to this watermarking unit, step 66. The watermarking unit thereafter embeds a unique watermark using the signal dependent properties p in the media signal, step 68. The media signal can then be used for display to an audience in a movie theatre if it is a video signal. Different clients can then embed their own unique watermark in the media signals they receive. The watermarking unit can furthermore be arranged to embed a watermark that is dependent on the date and time, such that the watermark of a copy of the media signal that is displayed changes from day to day and the time of day. In this way it is easier to track illegal copying and distribution.

In this way simple and trusted watermarking units can be placed at trusted clients, which then watermark the media signal locally based on the properties that have been determined beforehand. A content owner can furthermore inspect the effect of the watermark on the content and then manually modify specific features p such that the watermark energy is weaker or stronger in different frames of the signal. In this way he can ensure that the watermark is not perceptible.

The provision of the properties together with the media signal extends the bandwidth required for transmitting the information to the client. A fourth embodiment of the invention is directed towards solving this problem so that no extra bandwidth is needed for the properties.

A system according to this fourth embodiment of the invention is shown in a block schematic in FIG. 8. FIG. 8 is similar to FIG. 5 and only the differences will be described in detail here. The server includes a lossless encoding unit LE 72 which receives the media signal and the properties p and losslessly codes the properties in the media signal x for providing a modified signal x′. The modified signal x′ is then supplied to the sending unit 52 for sending to the client. The client device therefore also includes a lossless decoding unit 74, which extracts the properties p without losses from the media signal and then applies these properties in the watermarking unit 22. How this lossless embedding can take place is described in more detail in European Patent Application No. 03100093.8, which is herein incorporated by reference.

With this fourth embodiment there is no need for extra bandwidth for sending the properties.

The present invention has many advantages apart from the ones already described. The watermark embedding according to the invention is particularly well suited for forensic tracking, where watermarks are embedded in files distributed via an Electronic Content Delivery System, and used to track for instance illegal copied content on the Internet.

1. Method of simplifying embedding of watermarks in different copies of a media signal comprising the steps of:
determining watermarking properties (p) dependent on a media signal (x) (step 30; 58), and
storing the signal dependent properties (step 32; 60), such that the signal dependent properties can be used when embedding unique watermarks in different copies of the media signal.

2. Method according to claim 1, further comprising the step of sending the media signal together with information at least based on the signal depending properties to at least one recipient, (step 38; 62).

3. Method according to claim 2, further comprising the step of embedding unique watermarks (w_{A}, w_{B}, w_{C}) in different copies of the media signal using the stored signal dependent properties (step 36) and wherein the step of sending comprises sending a copy of the media signal to each recipient with an embedded unique watermark (x_{A}, x_{B}, x_{C}), (step 38).

4. Method according to claim 3, further comprising the step of mixing watermarks for providing a unique mix of the watermarks in copies of the media signal.

5. Method according to claim 2, wherein the step of sending comprises sending the media signal together with the signal dependent properties (step 62), for enabling embedding of a watermark by a recipient.

6. Method according to claim 5, further comprising the step of losslessly encoding the signal dependent properties in the media signal.

7. Method according to claim 1, wherein the signal dependent properties are based on a perceptual model of a human sensing system.

8. Method according to claim 1, wherein the steps of determining and storing are performed off-line and the step of sending is performed on-line.

9. Method of embedding a watermark in a media signal (x) comprising the steps of:
receiving a media signal together with certain watermarking properties (p) dependent on the media signal, (step 64), and
embedding a watermark (w_{A}) based on the signal dependent properties (p) in a copy of the media signal (x), (step 68).

10. Method according to claim 10, wherein the signal properties are losslessly encoded (LE) in the media signal (x′) and further comprising the step of losslessly decoding (LD) the signal properties from the media signal.

11. Device for simplifying the embedding of watermarks in different copies of a media signal comprising a server unit (10) including:
a properties determining unit (14) for determining signal dependent watermarking properties (p) of a media signal (x), and
a signal properties store (16) for storing the signal dependent properties, such that the signal dependent properties can be used for embedding unique watermarks in different copies of the media signal.

12. Device according to claim 11, further comprising a sending unit (28; 52) arranged to send the media signal together with information at least based on the signal depending properties to at least one recipient.

13. Device according to claim 12, further comprising at least one watermarking unit (22, 24, 26) for embedding unique watermarks (w_{A}, w_{B}, w_{C}) in different copies of the media signal using the stored signal dependent properties for enabling the sending of a uniquely watermarked media signal (x_{A}, x_{B}, x_{C}) to each recipient.

14. Device according to claim 13, wherein the sending unit (28) further comprises a mixing unit (50) arranged to mix watermarks such that the unique watermark sent to a recipient is a unique mix of the generated watermarks.

15. Device according to claim 12, wherein the sending unit (52) is arranged to send the media signal (x) together with the signal dependent properties (p), for enabling embedding of a watermark by a recipient.

16. Device according to claim 15, further comprising a lossless encoding unit (72) for losslessly encoding the signal dependent properties in the media signal.

17. Device according to claim 11, wherein the properties determining unit is arranged to determine the signal dependent properties based on a perceptual model of a human sensory system.

18. Device (54) for embedding a watermark in a media signal comprising:
a receiving unit (56) for receiving a media signal together with certain watermarking properties (p) dependent on the media signal (x), and
a watermarking unit (22) arranged to embed a watermark (w_{A}) based on the signal dependent properties (p) in a copy of the media signal.

19. Device according to claim 18, wherein the signal properties are losslessly encoded in the media signal and further comprising a lossless decoding unit (74) for losslessly decoding the signal properties from the media signal.

20. Signal for providing media content to a recipient comprising a media signal (x) together with certain watermarking properties (p), which are dependent on the media signal (x).

21. Signal according to claim 22, wherein the properties are losslessly embedded in the media signal.
